(19) United States
(12) Patent Application Publication
(10) Pub. No.: US 2021/0365487 A1
(43) Pub. Date: Nov. 25, 2021

(54) Word Library Management Method and Apparatus for input Method

(71) Applicant: SHENZHEN EAGLESOUL TECHNOLOGY CO., LTD., Shenzhen (CN)

(72) Inventors: Yingzhu CHEN, Shenzhen (CN); Kaipeng ZHANG, Dalian (CN); Xiaofeng ZHANG, Dalian (CN)

(21) Appl. No.: 16/467,574

(22) PCT Filed: Oct. 10, 2017
(86) PCT No.: PCT/CN2017/105552

§ 371 Date: Jun. 7, 2019

(30) Foreign Application Priority Data
Jul. 21, 2017 (CN) 201710600168.X

(51) Int. Cl. G06F 16/35; G06F 40/237; G06F 16/93; G06F 16/33

(52) U.S. Cl. CPC G06F 16/353; G06F 16/334; G06F 16/93; G06F 40/237

(57) ABSTRACT

The present disclosure discloses a word library management method and an apparatus for an input method including: firstly parsing information about answers to examination questions to form a masked entry library, and according to the masked entry library, performing operations on word libraries of an input method installed on a terminal device, the operations including transversing information about entries in each word library of the input method, and deleting entries that need to be masked, so that a normal examination or test can be carried out on a common terminal device without the need of preparing a dedicated terminal device or using a dedicated input method, which can prevent the result of the examination or test from being affected due to the word libraries and will neither affect the input of other characters during the examination nor affect the normal use of the terminal device and the input method.

### CROSS-REFERENCE TO RELATED APPLICATIONS

This application is a national stage application of PCT Application No. PCT/CN2017/105552. This application claims priority from PCT Application No. PCT/CN2017/105552, filed Oct. 10, 2017, and CN Application No. 201710600168.X, filed Jul. 21, 2017, the content of which is incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### TECHNICAL FIELD

The present disclosure relates to the technical field of intelligent input methods, and is used for word library management for an intelligent input method in a special application scenario, especially in an Internet teaching scenario, and particularly relates to a method and apparatus applied to an examination scenario and capable of managing a word library of an input method according to information about answers to examination questions.

### BACKGROUND ART

Since the emergence of the Chinese character input method in the 1990s last century, with the rapid development of computer technologies, especially due to the emergence of a variety of intelligent terminals as required, the input method as core means for human-machine interaction has become increasingly intelligent. The intelligence of the input method is mainly due to the increasingly powerful algorithm and the process learning ability on this basis, and the word library is an internal carrier for the intellectualization of the input method. Although word libraries of different input methods have different structures, but substantially comprise an index, a directory and entries. From the perspective of category, the word libraries can generally comprise a basic word library, a professional word library, and a user word library. At present, the input method system provided for various terminal devices is mainly to provide, based on the word library thereof and word frequencies in the word library (the usage frequencies of words), a user with a ranking of candidate words during information input, and preferentially displaying a common-used word with the highest word frequency, namely a preferred word. The ranking of the candidate words is an important indicator for the user's hit rate of preferred words during information input. The hit rate of preferred words means that when a user inputs certain keyboard information, the top ranked character, phrase or sentence is needed most by the user. However, in any case, the word library, especially information about entries in the word library, is the basic guarantee for the intellectualization of the input method.

CN201260222Y (Date of Publication: Jun. 17, 2009) discloses a mobile terminal, the mobile terminal comprising: an information collection and analysis module for collecting word information from information stored in the mobile terminal and analyzing the type of the word information; an association word library module for classifying and storing the word information according to the type of the word information; and an association engine module for reading, in a process of inputting information by a user, word information associated with the input information from the association word library module, and for using the word information as candidate words of an input method for the selection by the user. With the utility model, the commonly-used word information, such as contact names and mail addresses stored in a mobile terminal, is associated with an input method system, and is used as candidate words of the input method for the selection by the user, thereby improving the speed and accuracy of inputting the commonly-used information.

CN103823802A (Date of Publication: May 28, 2014) discloses a user-owned document-based word library construction method for an intelligent input method, which is used for constructing personalized word library information for the input method for a user, comprising: a cache memory unit for copying files on a hard disk, such as Word, Excel, PowerPoint documents, E-mails, and web pages in a cache; a vocabulary export module, the functions of which are to read all words from a user document, and save same as a file in the XML format, and then automatically upload same to a database; a word library download module, the functions of which are to download the XML file saved in the database to a client, and automatically import the words in the file into a user word library file; and a personalized word library storage unit for storing unique personalized word library information for the user. The invention further provides a corresponding method. The invention excavates the value of a user-owned document, so that the input method is more targeted, and this input method is beneficial for quick entering, and facilitates improving the efficiency of character input.

CN105718071A (Date of Publication: Jun. 29, 2016) discloses a terminal for recommending associated words in an input method, the terminal comprising: an acquisition module for acquiring current scenario information for a terminal when the terminal invokes an input method; an extraction module for extracting a recommended keyword library according to the current scenario information; and a recommendation module for recommending, in the input method, associated words related to a word in the recommended keyword library when the terminal inputs text by means of the input method. According to the invention, since the corresponding associated words are recommended in the input method according to different scenarios where a terminal is, the recommended associated words can more accurately adapt to the input requirements of a user in different scenarios, thereby improving the efficiency of the user inputting the associated words in the input method.

CN102346559A (Date of Publication: Feb. 8, 2012) discloses a method for deleting an entry in an input method, which is intended to solve the problems of a low input speed and a low accuracy of input of Chinese characters due to a high coincident-code rate in the existing input method. The method comprises: during character input, detecting, in real time, whether a user has input an entry deletion instruction, and when the entry deletion instruction input by the user is detected, deleting an entry specified by the entry deletion instruction from a word library, and outputting candidate words according to the word library from which the specified entry has been deleted, thereby achieving the purpose of dynamically deleting the entry in the word library, and since the specified entry has been deleted from the word library, the number of the output candidate words is reduced, so that the user can select a target word from the candidate words quickly and accurately. The patent application is intended to solve the problem of input speed and is intended to solve the problem of input accuracy, which deletes an entry according to a user's instruction, and for the existing intelligent input method, this deletion operation is inefficient and is not practical.

In the prior art, the pursuit of intelligence of the input method has never ceased, and the intellectualized selection of user input is improved by means of various possible processing methods. However, in some special application scenarios, especially when an examination or test is carried out by using a terminal, or even doing exercises, too intellectualized associations and recommendations make it not necessary for users to seriously remember and to carefully distinguish and recognize input contents. On the other hand, too intellectualized associations and recommendations make it impossible to achieve the evaluation result of the examination during the examination, and may also lead to unfairness of the examination due to the individualized differences in word libraries on different terminals. In order to solve problems in this aspect, the solution generally employed in the prior art is using dedicated terminal devices and/or a dedicated input method or input devices. From a cost perspective, it takes time and effort to organize an examination, and these dedicated devices are often difficult to use and are high in purchase and maintenance costs. If it is not a major examination, it is usually unnecessary to use the dedicated devices. On the other hand, by means of the dedicated input method, other input methods usually need to be deleted and masked, and an unfamiliar input method is used, which greatly reduces the user experience and reduces the input efficiency of other contents except those involving information about answers.

In view of the problems existing in the prior art, the present disclosure is intended to provide a word library management method and apparatus for an intelligent input method. For an input method on a common terminal device, when a special application is performed, such as when an examination or test is carried out by using the terminal device and the input method, by running the word library management method of the present disclosure, masked deletion operations can be performed on information about some entries in the word library of the intelligent input method, so that it is possible to carry out special applications such as an examination by using the common terminal device and the input method familiar to a user, without affecting the test result and the user experience and efficiency.

Therefore, a heretofore unaddressed need exists in the art to address the aforementioned deficiencies and inadequacies.

### SUMMARY OF THE INVENTION

According to a first aspect of the present disclosure, it is intended to provide a word library management method for an input method in an Internet teaching scenario, comprising the following steps:

an entry parsing step for acquiring a document to be parsed, first dividing the document into phrases by using a spacer as a boundary condition, and then performing progressive entry parsing on the phrases to generate a masked entry library composed of a series of entries each having two or more characters; and

an entry filtering step for acquiring word libraries of an input method, querying, according to the masked entry library, whether an entry in the masked entry library exists in the word libraries, and if so, deleting an entry record having the same content as that in the masked entry library from the word libraries.

Preferably, prior to the performing of the entry filtering step, a word library backup step is first performed to back up the word libraries of the input method, so that word libraries used prior to the performing of the entry filtering step can be restored ex post facto.

Preferably, during the performing of the entry filtering step, all the word libraries of the input method are searched, and entry information about all the word libraries of the input method is traversed so as to complete the entry filtering step.

Prior to the performing of the entry parsing step, a document filtering step is performed to replace numbers or letters in the document, in units of groups of same consecutive in position, with one spacer per group; and

after the performing of the entry parsing step, a document deletion step is performed, in which for the document to be parsed, after the entry parsing is completed, the content of the document is deleted.

The progressive entry parsing of a phrase comprises: in the order of characters in the phrase, and from front to rear, respectively using each of the characters as a first character to perform traversal and parsing backwards, so as to form a series of entries, each having at least two characters, from the phrase.

The entry parsing step further comprises a merging operation on identical masked entries, for merging identical entries parsed from different phrases, and saving same as one masked entry to the masked entry library.

The entry filtering step further comprises an operation of deleting the masked entry library, in which after the completion of traversal of all the word libraries of the input method and the completion of filtering of all the masked entries, the masked entry library is deleted.

The spacer comprises at least one of a space, a carriage return, and a punctuation mark.

According to a second aspect of the present disclosure, it is intended to provide a word library management apparatus for an input method, comprising an entry parsing unit and an entry filtering unit, wherein

the entry parsing unit is used for acquiring a document to be parsed, first dividing the document into phrases by using a spacer as a boundary condition, and then performing progressive entry parsing on the phrases to generate a masked entry library composed of a series of entries each having two or more characters; and

the entry filtering unit is used for acquiring word libraries of an input method, querying, according to the masked entry library, whether an entry in the masked entry library exists in the word libraries, and if so, deleting an entry record having the same content as that in the masked entry library from the word libraries.

The apparatus further comprises a word library backup unit.

Preferably, the word library backup unit is used for performing, prior to the performing of the entry filtering by the entry parsing unit, word library backup to back up the word libraries of the input method, so that word libraries used prior to the performing of the entry filtering can be restored ex post facto.

Preferably, during the performing of the entry filtering, the entry filtering unit searches for all the word libraries of the input method and traverses information about entries in all the word libraries of the input method, so as to complete the entry filtering unit.

The apparatus further comprises a document filtering unit and a document deletion unit, wherein

the document filtering unit is used for performing, prior to the performing of the entry parsing by the entry parsing unit, document filtering to replace numbers or letters in the document, in units of groups of same consecutive in position, with one spacer per group; and

the document deletion unit is used for performing, after the performing of the entry parsing by the entry parsing unit, document deletion in which for the document to be parsed, after the entry parsing is completed, the content of the document is deleted.

The progressive entry parsing of a phrase comprises: in the order of characters in the phrase, and from front to rear, respectively using each of the characters as a first character to perform traversal and parsing backwards, so as to form a series of entries, each having at least two characters, from the phrase.

The entry parsing unit is further used to perform a merging operation on identical masked entries, for merging identical entries parsed from different phrases, and saving same as one masked entry to the masked entry library.

The entry filtering unit is further used for performing an operation of deleting the masked entry library, in which after the completion of traversal of all the word libraries of the input method and the completion of filtering of all the masked entries, the masked entry library is deleted.

The spacer comprises at least one of a space, a carriage return, and a punctuation mark.

According to a further aspect of the present disclosure, it is intended to provide a computer device, comprising a memory, a processor, and a computer program stored on the memory and operable on the processor, wherein the program, when executed by the processor, can implement the steps of the method as described above.

According to a still further aspect of the present disclosure, it is intended to provide a computer storage medium storing a program executable by a computer, wherein the program, when executed, can implement the steps of the method as described above.

In the prior art, for such a special application scenario as an examination, it is usually required to use dedicated terminal devices and use an extremely inefficient input method without an intelligent word library to solve the problem, which greatly increases the cost of organizing an examination by an educational institution at ordinary times. The present disclosure discloses a word library management method and apparatus for an input method, which is used for the management of the input method in a special application scenario, such as during an examination. The method comprises: firstly parsing information about answers to examination questions to form a masked entry library, and then, according to the masked entry library, performing operations on word libraries of an input method installed on a terminal device, such as a desktop computer, a laptop computer, a PAD, and a smart phone, the operations including transversing information about entries in each word library of the input method, and deleting entries that need to be masked, so that a normal examination or test can be carried out on a common terminal device without the need of preparing a dedicated terminal device or using a dedicated input method, which can prevent the result of the examination or test from being affected due to the intelligent input function of the word libraries and will neither affect the input of other characters during the examination nor affect the normal use of the terminal device and the input method therein during a non-examination period, thereby improving the usage experience of a user and reducing the cost of organizing the examination or test. The execution of the word library management method of the present disclosure before the starting of a special application scenario, for example, before the starting of an examination, and the execution of the management method on an input method on a terminal device effectively avoid the possibility of easily acquiring examination answers due to an intelligent association function of a word library of the input method.

The above-mentioned and further objectives and features of the present disclosure will become more apparent and complete from the following detailed description in conjunction with the drawings.

### BRIEF DESCRIPTION OF THE DRAWINGS

The above and other features and advantages in the present disclosure will become more apparent by describing, in detail, the exemplary embodiments thereof with reference to the accompanying drawings.

FIG. 1 is a flowchart of application steps according to the present disclosure;

FIG. 2 is a flowchart of word library management according to the present disclosure; and

FIG. 3 is a flowchart of word library parsing according to the present disclosure.

### DETAILED DESCRIPTION OF PRESENT DISCLOSURE

The present disclosure will now be described more fully hereinafter with reference to the accompanying drawings, in which exemplary embodiments of the present disclosure are shown. The present disclosure may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It is appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It is understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It is understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present disclosure.

It is understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It are also appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It is further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It is understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present disclosure belongs. It is further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

Embodiments of the invention are illustrated in detail hereinafter with reference to accompanying drawings. It should be understood that specific embodiments described herein are merely intended to explain the invention, but not intended to limit the invention.

The disclosure will now be described in details in connection with the embodiments. The following embodiments are intended for facilitating those skilled in the art to understand the present disclosure, instead of limiting the present disclosure in any way. It should be noted that a number of variations and modifications may be made by those skilled in the art without departing from the inventive concept, all of which fall within the scope of protection of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip.

The term module may include memory (shared, dedicated, or group) that stores code executed by the processor. The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

In the present disclosure, computer components may include physical hardware components and virtual software components. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The detailed description of the present disclosure will be further described in detail below in conjunction with the drawings.

The word library management method and apparatus for an input method in the present disclosure are intended to realize the use of an intelligent input method in a special application scenario. The special application scenarios described in the present disclosure are mainly scenarios having examination or investigation requirements, such as examinations, tests, and exercises, and mainly relate to the field of education and teaching, and particularly to the field of Internet teaching. For a terminal device used for performing an examination, test or exercise, the method and apparatus of the present disclosure are run prior to the conversion from a common application to a special application.

The terminal device in the present disclosure may comprise a processor, a network module, a control module, a display module, an intelligent operating system and an intelligent input method, and may be a smart phone, a PAD, a laptop computer, a desktop computer, etc. The terminal can be provided with a variety of data interfaces for connecting to various extension devices and accessories via a data bus. The intelligent operating system comprises Windows, Android and its improvements, and iOS, on which application software can be installed and run, and the functions of various types of application software, services, and application program stores/platforms under the intelligent operating system are realized.

The terminal device can be connected to the Internet through RJ45/Wi-Fi/Bluetooth/2G/3G/4G/G.hn/Zigbee/Z-ware/RFID, etc., and can be connected to other terminals or other computers and devices via the Internet. By using a variety of data interfaces or bus modes, such as 1394/USB/serial/SATA/SCSI/PCI-E/Thunderbolt/data card interface, and by using a connection mode like an audio and video interface, such as HDMI/YpbPr/SPDIF/AV/DVI/VGA/TRS/SCART/Displayport, various extension devices and accessories are connected to constitute a conference/teaching device interaction system. The functions of acoustic control and shape control are realized by using a sound capture control module and a motion capture control module in the form of software, or by using a sound capture control module and a motion capture control module in the form of data bus on-board hardware. The display, projection, voice access, audio and video playing, as well as digital or analog audio and video input and output functions are realized by connecting to a display/projection module, a microphone, a sound device and other audio and video devices via audio and video interfaces. The image access, sound access, use control and screen recording of an electronic whiteboard, and an RFID reading function are realized by connecting to a camera, a microphone, the electronic whiteboard and an RFID reading device via data interfaces, and a mobile storage device, a digital device and other devices can be accessed and managed and controlled via corresponding interfaces. The functions including manipulation, interaction and screen shaking between multi-screen devices are realized by means of DLNA/IGRS technologies and Internet technologies. That is to say, the terminal device of the present disclosure may generally be a terminal device that performs network teaching.

In the present disclosure, the processor is defined to include but not limited to: an instruction execution system, such as a computer/processor-based system, an application specific integrated circuit (ASIC), a computing device, or a hardware and/or software system capable of fetching or acquiring logic from a non-transitory storage medium or a non-transitory computer readable storage medium and executing instructions contained in the non-transitory storage medium or the non-transitory computer readable storage medium. The processor may further comprise any controller, state machine, microprocessor, Internet-based entity, service or feature, or any other analog, digital, and/or mechanical implementation thereof.

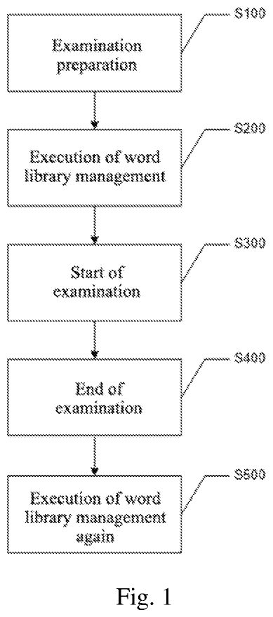

As shown in FIG. 1, it is a flowchart of application steps according to the present disclosure. The application steps specifically comprise: examination preparation S100, execution of word library management S200, start of examination S300, end of examination S400, and execution of word library management again S500.

For step S100, by taking the Internet teaching as an example, when a user performs an examination, test, or excise using a terminal device for learning at ordinary times, the terminal device enters an examination preparation state, an Internet teaching system prepares to invoke the word library management program of an input method of the present disclosure, and sends information about answers to this examination, test, or excise via a server to each terminal device in the form of text content. In order to avoid the situation where a user fails to accurately know about whether he or she has mastered the contents that need to be examined or tested due to an intelligent function of an input method, such as an association function, for example, for a blank-filling question in a Chinese examination “ [symbol] (The sun beyond the mountain glows), ______”, in many intelligent input methods, as long as “ [symbol] ” is input, “ [symbol] (The Yellow River seawards flows)” is automatically prompted, therefore, according to the settings of an administrator, in a special application scenario such as an examination, test, or exercise, the method and apparatus of the present disclosure are first run to perform a management operation on a word library of an input method.

For step S200, after the Internet teaching system is invoked, for each terminal device, the word library management program for the input method of the present disclosure starts running: it manages all word libraries of all input methods on the terminal device according to the information about answers, and performs operations on entry records in the word libraries, which may intelligently prompt answers.

For step S300, after receiving an indication that the word library management program has traversed all the word libraries of all the input methods and has completed corresponding operations, the Internet teaching system officially performs an examination operation, and the user answers questions by using the terminal device.

For step S400, after receiving information indicating that the user has completed question answering, the Internet teaching system confirms that the examination has ended and is ready to invoke the word library management program again.

For step S500, after receiving an indication that the user has completed the examination, the word library management program is invoked by the Internet teaching system to run again to perform step S206 below: traversing all the input methods, and overwriting the current word libraries with the previously backed up word libraries, so that all the word libraries of all the input methods on the terminal device are restored to the state before the examination.

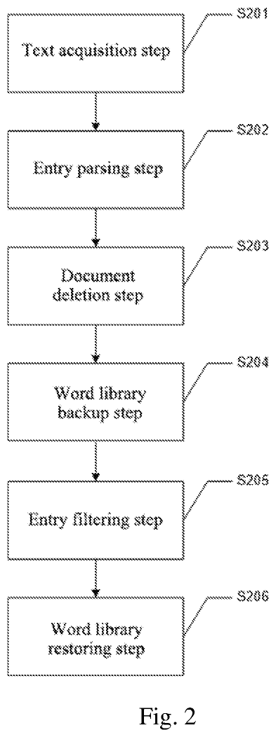

As shown in FIG. 2, it is a flowchart of word library management according to the present disclosure. Specifically, step S200 further comprises: a text acquisition step S201, an entry parsing step S202, a document deletion step S203, a word library backup step S204, an entry filtering step S205, and a word library restoring step S206.

The text acquisition step S201 is used for: when the word library management program of the present disclosure is invoked by the Internet teaching system, firstly, detecting whether the system provides a document which contains answers and on which a mask operation needs to be performed; and if so, acquiring the document and preparing to parse the document, and if not, generating prompt information and sending same to a server end of the Internet teaching system. The document is text information about answers to examination questions or test questions, and these pieces of text information usually have the serial numbers related to the questions, punctuation marks used thereamong (including dot marks, labels, and symbols commonly used in Chinese and English), and operation symbols (such as carriage return symbols and space symbols), as well as character contents, letter contents, digital contents, formula contents, etc. The spacer comprises at least one of a space, a carriage return, and a punctuation mark.

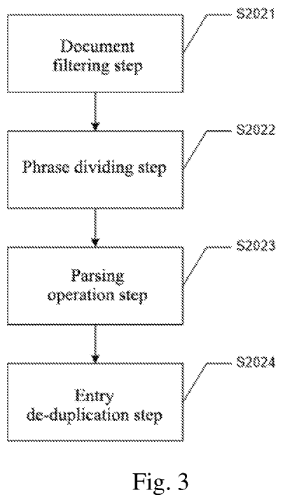

The entry parsing step S202 is used for parsing the document so as to acquire a masked entry library. As shown in FIG. 3, it is a flowchart of word library parsing according to the present disclosure. Specifically, step S202 further comprises: a document filtering step S2021, a phrase dividing step S2022, a parsing operation step S2023, and an entry de-duplication step S2024.

The document filtering step S2021 is used for replacing numbers, letters and/or punctuation marks in the document, in units of groups of same consecutive in position, with one spacer per group. For example, in “14 (a) [symbol] ”, “14”, “(”, “a”, and “)” are a group of symbols which are consecutive in position and are respectively a number, a punctuation mark, a letter and a punctuation mark, and during the processing of the document, this group is replaced with one spacer, such as one space, one carriage return symbol, or one punctuation mark.

Optionally, the formula-type content, such as a mathematical formula and a physical formula, may also be replaced with one spacer, because in general, such a formula generally does not have an association storage function in a word library of an input method. After the replacement operation regarding the spacers is completed, progressive entry parsing is performed on various answer contents in the document, mainly the character contents separated from each other by the spacers.

The phrase dividing step S2022 is used for acquiring a filtered document to be parsed, dividing the document into phrases by using a spacer as a boundary condition, and then performing progressive entry parsing on the phrases to generate a masked entry library composed of a series of entries each having two or more characters.

The parsing operation step S2023 is used for performing, after phrase dividing is completed, progressive entry parsing on a phrase, comprising: in the order of characters in the phrase, and from front to rear, respectively using each of the characters as a first character to perform traversal and parsing backwards, so as to form a series of entries, each having at least two characters, from the phrase. For example, for these separated contents, parsing processing is performed on phrases each having two or more characters, for example, “ [symbol] ” is parsed into ten masked entries, namely, “ [symbol] ”, “ [symbol] ”, “ [symbol] [symbol] ”, “ [symbol] ”, “ [symbol] ”, “ [symbol] ”, “ [symbol] ”, “ [symbol] ”, “ [symbol] ”, and “ [symbol] ”, which are sequentially encoded and then stored in the masked entry library. The entry parsing step further comprises a merging operation on identical masked entries, for merging identical entries parsed from different phrases, and saving same as one masked entry to the masked entry library.

The entry de-duplication step S2024 is used for performing a de-duplication operation on the parsed entries. After an answer document is parsed, there is a high possibility that identical masked entries exist, for example, it may be possible to parse out multiple “ [symbol] ”, and if each “ [symbol] ” is used as one masked entry, the subsequent workload of comparison will be increased. Preferably, in order to improve the efficiency of subsequent comparison, after the parsing of the answer document is completed, the identical masked entries are checked for duplication, and a merge operation is performed on the masked entries having the same content, and a plurality of masked entries having the same content are saved in the masked entry library as one record.

The present disclosure mainly applies to the types of examinations with answers in the form of Chinese characters, and since English or other foreign languages have their particularities in expression, the present disclosure is not intended to completely cover all the cases. However, according to the spirit of the present disclosure, the present disclosure can be applied to a scenario where the main answer contents are in foreign languages, which is also within the scope of protection of the present disclosure. The entry parsing step needs to acquire text information about answers to an examination, test and exercise in advance, and by performing progressive parsing of entries, all possible masked entries can be obtained to form a masked entry library.

The document deletion step S203 is used for deleting the answer document after the entry parsing operation is completed. For the consideration of confidentiality, after the entry parsing step is performed, the document deletion step is performed, in which for an answer document that is to be parsed and has been parsed, after entry parsing is completed, the content of the document is deleted. The deletion operation may be in a way of file shredding.

The word library backup step S204 is used for obtaining, prior to the performing of entry filtering, all the original word libraries of all the input methods on the terminal device, and conducting backup, making it convenient for a user to restore the original word libraries after the end of the examination. For a specific terminal device, after the operation authority of all the word libraries of the input method is obtained, a word library backup step is performed to back up the word libraries of the input method, so that word libraries used prior to the performing of the entry filtering step can be restored ex post facto. For the backed-up word library, after the special application scenario ends, the current word library is overwritten with the backed-up word library, so that the terminal device can be restored to the state prior to the application scenario.

For the entry filtering step S205, performing the entry filtering step by using a de-duplicated entry list, namely a masked entry library, comprises: first acquiring word libraries of an input method, querying, according to the masked entry library, whether an entry in the masked entry library exists in the word libraries, and if so, deleting an entry record having the same content as that in the masked entry library from the word libraries. For example, the ten entries of “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, etc., are compared with the entry contents in information about entries in the word library, and the deletion operation is performed on the same entry categories existing in the word library.

Preferably, when the method or apparatus of the present disclosure is run, for a specific terminal device, all input methods installed thereon are traversed, and a modification operation authority of all the word libraries of all the input methods is acquired. In the existing intelligent input methods, the operations of many word libraries themselves are open without the need of obtaining a permission for special authorities. For the case where a special permission needs to be obtained for operation, it is necessary to obtain a permission from a copyright party of the relevant input method in advance. For the case where permissions cannot be obtained, the use of a certain input method is limited by input method disabling.

Preferably, according to historical usage records of the user on the terminal device, the user's favorite input method(s) is(are) obtained, on which the entry filtering operation is preferentially performed. Preferably, during the performing of the entry filtering step, all word libraries of the input method are searched, and entry information about all the word libraries of the input method is traversed so as to complete the entry filtering step. In general, the word libraries of an input method comprise a basic word library, a professional word library, and a user-owned word library, etc.

Preferably, after the entry filtering operation is completed, an operation of deleting the masked entry library is further included, in which after the completion of traversal of all the word libraries of the input method and the completion of filtering of all the masked entries, the masked entry library is deleted. After the entry filtering of all the word libraries of all the input methods on the terminal device is completed, the masked entry library is deleted. The deleting comprises deleting in a way of file shredding, so that the information about answers can be kept as confidential as possible.

The word library restoring step S206 is used for restoring the previously backed-up word libraries after the re-invoking of the Internet teaching system and confirming that the examination has ended, and deleting the word libraries of the input method used in the current examination. Preferably, the input method actually used by the user during the examination as well as the word libraries thereof are obtained, and only the previously backed-up word libraries for this part of word library of the input method need to be restored.

Preferred embodiments of the present disclosure introduced above are intended to make the spirit of the present disclosure more apparent and easy to understand, but not to limit the present disclosure. Any updates, replacements and improvements made within the spirit and principles of the present disclosure should be regarded as within the scope of protection of the claims of the present disclosure.

### INDUSTRIAL APPLICABILITY

The present disclosure discloses a word library management method and apparatus for an input method, which is used for the management of the input method in a special application scenario, so that a normal examination or test can be carried out on a common terminal device without the need of preparing a dedicated terminal device or using a dedicated input method, which can prevent the result of the examination or test from being affected due to the intelligent input function of the word libraries and will neither affect the input of other characters during the examination nor affect the normal use of the terminal device and the input method therein during a non-examination period, thereby improving the usage experience of a user and reducing the cost of organizing the examination or test.

The foregoing description of the exemplary embodiments of the present disclosure has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. A word library management method for an input method, comprising the following steps:
an entry parsing step for acquiring a document to be parsed, first dividing the document into phrases by using a spacer as a boundary condition, and then performing progressive entry parsing on the phrases to generate a masked entry library composed of a series of entries each having two or more characters; and
an entry filtering step for acquiring word libraries of an input method, querying, according to the masked entry library, whether an entry in the masked entry library exists in the word libraries, and if so, deleting an entry record having the same content as that in the masked entry library from the word libraries.

2. The method according to claim 1, wherein
prior to the performing of the entry filtering step, preferably, a word library backup step is first performed to back up the word libraries of the input method, so that word libraries used prior to the performing of the entry filtering step can be restored ex post facto.

3. The method according to claim 2, wherein
during the performing of the entry filtering step, preferably, all the word libraries of the input method are searched, and information about entries in all the word libraries of the input method is traversed so as to complete the entry filtering step.

4. The method according to claim 3, wherein
prior to the performing of the entry parsing step, a document filtering step is performed to replace numbers or letters in the document, in units of groups of same consecutive in position, with one spacer per group; and
after the performing of the entry parsing step, a document deletion step is performed, in which for the document to be parsed, after the entry parsing is completed, the content of the document is deleted.

5. The method according to claim 4, wherein
the progressive entry parsing of a phrase comprises: in the order of characters in the phrase, and from front to rear, respectively using each of the characters as a first character to perform traversal and parsing backwards, so as to form a series of entries, each having at least two characters, from the phrase.

6. The method according to claim 5, wherein
the entry parsing step further comprises a merging operation on identical masked entries, for merging identical entries parsed from different phrases, and saving same as one masked entry to the masked entry library.

7. The method according to claim 6, wherein
the entry filtering step further comprises an operation of deleting the masked entry library, in which after the completion of traversal of all the word libraries of the input method and the completion of filtering of all the masked entries, the masked entry library is deleted.

8. The method according to claim 7, wherein
the spacer comprises at least one of a space, a carriage return, and a punctuation mark.

9. A computer device, comprising a memory, a processor, and a computer program stored on the memory and operable on the processor, wherein the program, when executed by the processor, can implement the steps of a method, comprising the following steps:
an entry parsing step for acquiring a document to be parsed, first dividing the document into phrases by using a spacer as a boundary condition, and then performing progressive entry parsing on the phrases to generate a masked entry library composed of a series of entries each having two or more characters; and
an entry filtering step for acquiring word libraries of an input method, querying, according to the masked entry library, whether an entry in the masked entry library exists in the word libraries, and if so, deleting an entry record having the same content as that in the masked entry library from the word libraries.

10. A computer storage medium, storing a program executable by a computer, wherein the program, when executed, can implement the steps of a method, comprising the following steps:
an entry parsing step for acquiring a document to be parsed, first dividing the document into phrases by using a spacer as a boundary condition, and then performing progressive entry parsing on the phrases to generate a masked entry library composed of a series of entries each having two or more characters; and
an entry filtering step for acquiring word libraries of an input method, querying, according to the masked entry library, whether an entry in the masked entry library exists in the word libraries, and if so, deleting an entry record having the same content as that in the masked entry library from the word libraries.

11. The method according to claim 9, wherein
prior to the performing of the entry filtering step, preferably, a word library backup step is first performed to back up the word libraries of the input method, so that word libraries used prior to the performing of the entry filtering step can be restored ex post facto.

12. The method according to claim 11, wherein
during the performing of the entry filtering step, preferably, all the word libraries of the input method are searched, and information about entries in all the word libraries of the input method is traversed so as to complete the entry filtering step.

13. The method according to claim 12, wherein
prior to the performing of the entry parsing step, a document filtering step is performed to replace numbers or letters in the document, in units of groups of same consecutive in position, with one spacer per group; and
after the performing of the entry parsing step, a document deletion step is performed, in which for the document to be parsed, after the entry parsing is completed, the content of the document is deleted.

14. The method according to claim 13, wherein
the progressive entry parsing of a phrase comprises: in the order of characters in the phrase, and from front to rear, respectively using each of the characters as a first character to perform traversal and parsing backwards, so as to form a series of entries, each having at least two characters, from the phrase.

15. The method according to claim 14, wherein
the entry parsing step further comprises a merging operation on identical masked entries, for merging identical entries parsed from different phrases, and saving same as one masked entry to the masked entry library.

16. The method according to claim 10, wherein
prior to the performing of the entry filtering step, preferably, a word library backup step is first performed to back up the word libraries of the input method, so that word libraries used prior to the performing of the entry filtering step can be restored ex post facto.

17. The method according to claim 16, wherein
during the performing of the entry filtering step, preferably, all the word libraries of the input method are searched, and information about entries in all the word libraries of the input method is traversed so as to complete the entry filtering step.

18. The method according to claim 17, wherein
prior to the performing of the entry parsing step, a document filtering step is performed to replace numbers or letters in the document, in units of groups of same consecutive in position, with one spacer per group; and
after the performing of the entry parsing step, a document deletion step is performed, in which for the document to be parsed, after the entry parsing is completed, the content of the document is deleted.

19. The method according to claim 18, wherein
the progressive entry parsing of a phrase comprises: in the order of characters in the phrase, and from front to rear, respectively using each of the characters as a first character to perform traversal and parsing backwards, so as to form a series of entries, each having at least two characters, from the phrase.

20. The method according to claim 19, wherein
the entry parsing step further comprises a merging operation on identical masked entries, for merging identical entries parsed from different phrases, and saving same as one masked entry to the masked entry library.
